(19) United States
(12) Patent Application Publication
(10) Pub. No.: US 2017/0066499 A1
(43) Pub. Date: Mar. 9, 2017

(54) BICYCLE PEDAL

(71) Applicant: Hsing Ta Industrial Co., Ltd., New Taipei City (TW)

(72) Inventor: Ta-Ching Yang, New Taipei City (TW)

(21) Appl. No.: 14/849,588

(22) Filed: Sep. 9, 2015

(51) Int. Cl. B62M 3/08

(52) U.S. Cl. CPC B62M 3/086

(57) ABSTRACT

A bicycle pedal includes a rotation axle; a pedal body movably coupled to the rotation axle and including an axle sleeve section, two hollowed areas, and a first retention block assembly and a second retention block assembly; first and second adjustment mechanisms respectively arranged in the hollowed areas and each including a fixing bolt arranged in the hollowed area, a holding seat fit over the fixing bolt and abutting one side of the first or second retention block assembly, an elastic element fit over the fixing bolt and having an end abutting one side of the second or first retention block assembly, and an adjustment section movably mounted to the holding seat and abutting an opposite end of the elastic element; and a clip block mounted, in a removable manner, between the first adjustment mechanism and the second adjustment mechanism.

### (a) TECHNICAL FIELD OF THE INVENTION

The present invention relates generally to innovation of bicycle pedal, and more particularly to a pedal for off-road competition bicycles.

### (b) DESCRIPTION OF THE PRIOR ART

Taiwan Patent No. I474949 discloses a “bicycle pedal”, which comprises a pedal axle, a main body, a coupling mechanism, and a clip movement constraint member. The main body is rotatably supported by the pedal axle. The coupling mechanical comprises a clip fixing member that is coupled to a front part of a clip, and a clip fixing member that is coupled to a rear part of the clip. The clip movement constraint member constrains the movement of the clip in a rearward direction and, in releasing the clip, conducts the clip in a manner of being released from the coupling mechanism.

However, the bicycle pedal known from the above patent document comprises an energizing member (which is a torsion spring) that is in abutting engagement with the main body and the clip movement constraint member so that when an adjustment mechanism is operated to adjust the energization power of the energizing member (namely tightness of the spring), the energizing member can only achieve one-side force application by means of the compression force applied through abutting against the clip movement constraint member. In other words, when a torsion force induced in the energizing member is adjusted through adjustment made with the adjustment mechanism to be 10 Kg, a similar force of 10 Kg is generated through the one-side force application. This although achieving a desired effect of the above patent document, may still cause insufficiency of torsion force in an actual application.

### SUMMARY OF THE INVENTION

The primary object of the present invention is to allow two ends of an elastic element respectively abutting against a second retention block assembly or a first retention block assembly and an associated adjustment section so that when the adjustment section is operated to adjust a torsion force of the elastic element, an effect of clamping from both sides is achieved to significantly improve tightness and secureness of clamping a clip block.

To achieve the above object, the present invention provides a bicycle pedal, which comprises: a rotation axle; a pedal body movably coupled to the rotation axle and comprising an axle sleeve section, hollowed areas respectively formed in front and rear sides of the axle sleeve section, and a first retention block assembly and a second retention block assembly respectively arranged on opposite surfaces of the axle sleeve section; a first adjustment mechanism arranged in one of the hollowed areas and comprising a fixing bolt arranged in the hollowed area, a holding seat fit over the fixing bolt and abutting one side of the first retention block assembly, an elastic element fit over the fixing bolt and having an end abutting one side of the second retention block assembly, and an adjustment section movably mounted to the holding seat and abutting an opposite end of the elastic element; a second adjustment mechanism arranged in another one of the hollowed areas and comprising a fixing bolt arranged in the hollowed area, a holding seat fit over the fixing bolt and abutting an opposite side of the second retention block assembly, an elastic element fit over the fixing bolt and having an end abutting an opposite side of the first retention block assembly, and an adjustment section movably mounted to the holding seat and abutting an opposite end of the elastic element; and a clip block, which is mounted, in a removable manner, between the first adjustment mechanism and the second adjustment mechanism.

In an embodiment of the present invention, the rotation axle has an end to which a bearing is mounted and an opposite end comprising a threaded section formed thereon. The bearing is received in the axle sleeve section and the threaded section extends beyond and outside an end of the axle sleeve section.

In an embodiment of the present invention, each of the holding seats has a surface on which a graduation section is provided and each of the holding seats has an end that forms an extension tab on which the adjustment section is mounted.

In an embodiment of the present invention, the elastic element of the first adjustment mechanism comprises a torsion spring and the elastic element has an end that forms an abutment section abutting one side of the second retention block assembly and an opposite end that forms a pulling section abutting the adjustment section.

In an embodiment of the present invention, the elastic element of the second adjustment mechanism comprises a torsion spring and the elastic element has an end that forms an abutment section abutting one side of the first retention block assembly and an opposite end that forms a pulling section abutting the adjustment section.

In an embodiment of the present invention, each of the adjustment sections comprises an adjustment screw extending through and coupled to the extension tab and a pull plate mounted to the adjustment screw, the pull plate having a surface positioned against the pulling section.

In an embodiment of the present invention, each of the pull plates has an end forming an indication section corresponding to the graduation section.

In an embodiment of the present invention, the clip block comprises a mounting hole formed in a middle portion thereof and the clip block has an end that forms a first constraint section and an opposite end that forms a second constraint section, the first constraint section being fit in the abutment section of one of the elastic elements, the second constraint section being fit in and abutting an inside surface of one of the holding seats.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a top plan view of the present invention.

FIG. 4 is another top plan view of the present invention.

FIG. 5 is a schematic view illustrating adjustment made according to the present invention.

FIG. 6 is a schematic view illustrating a released state of a clip block according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

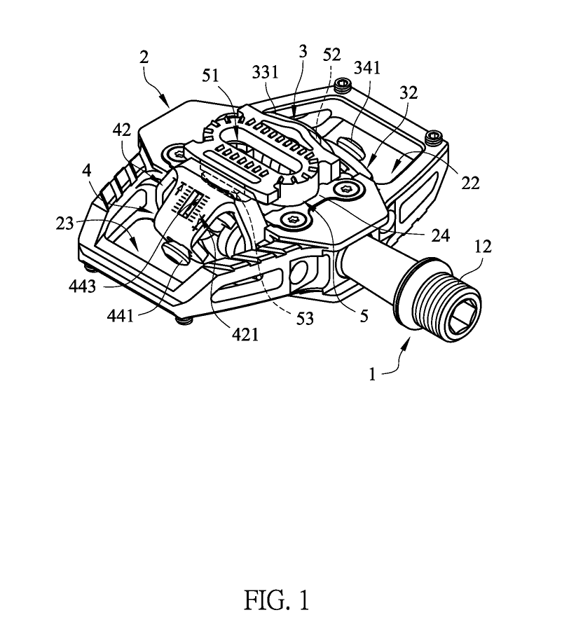

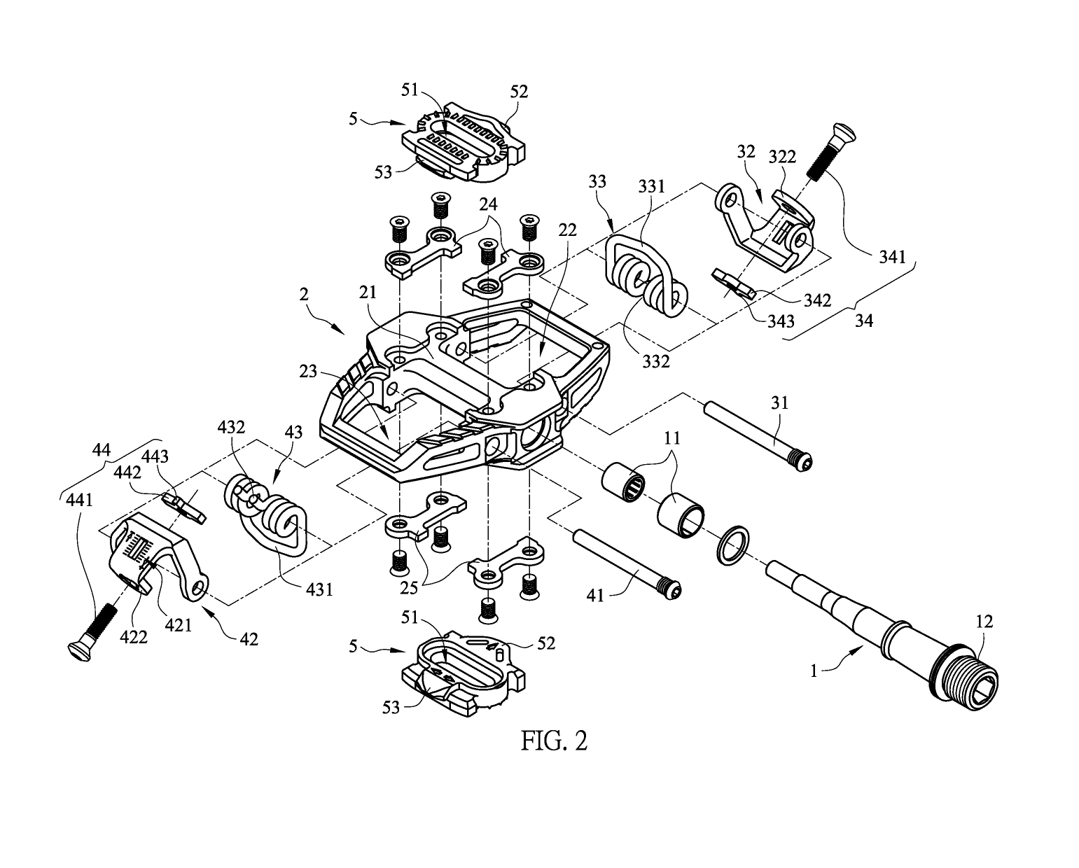

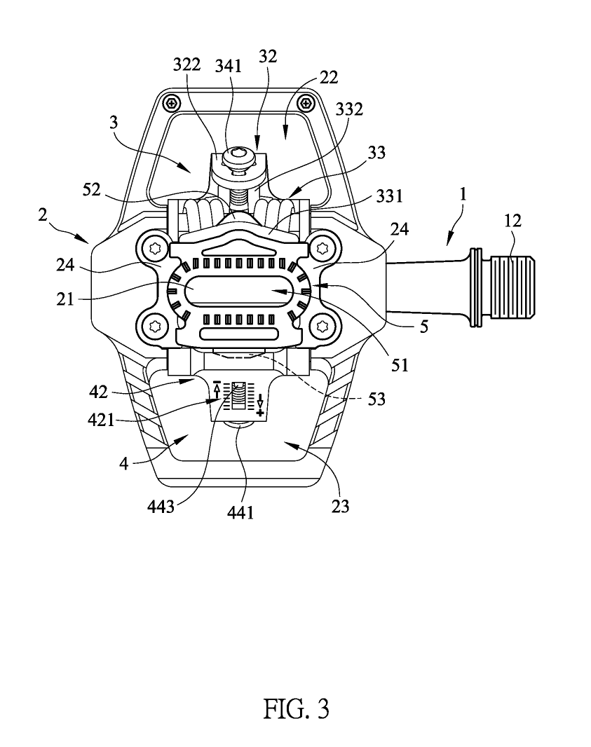

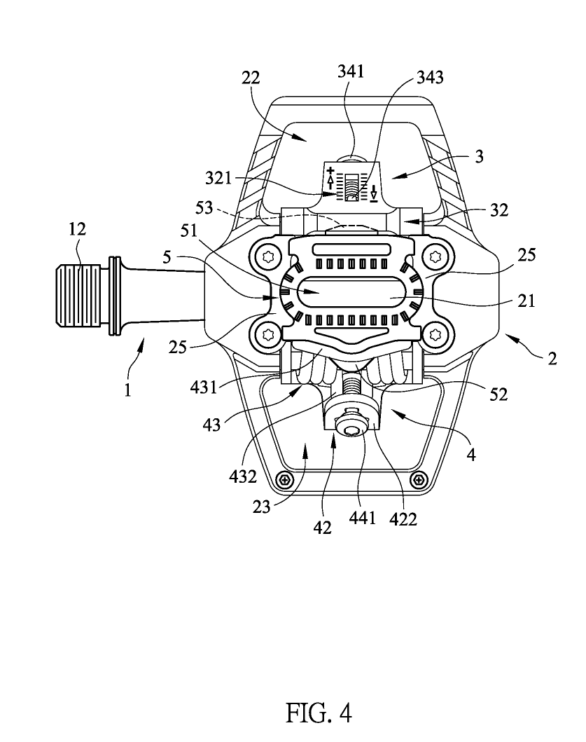

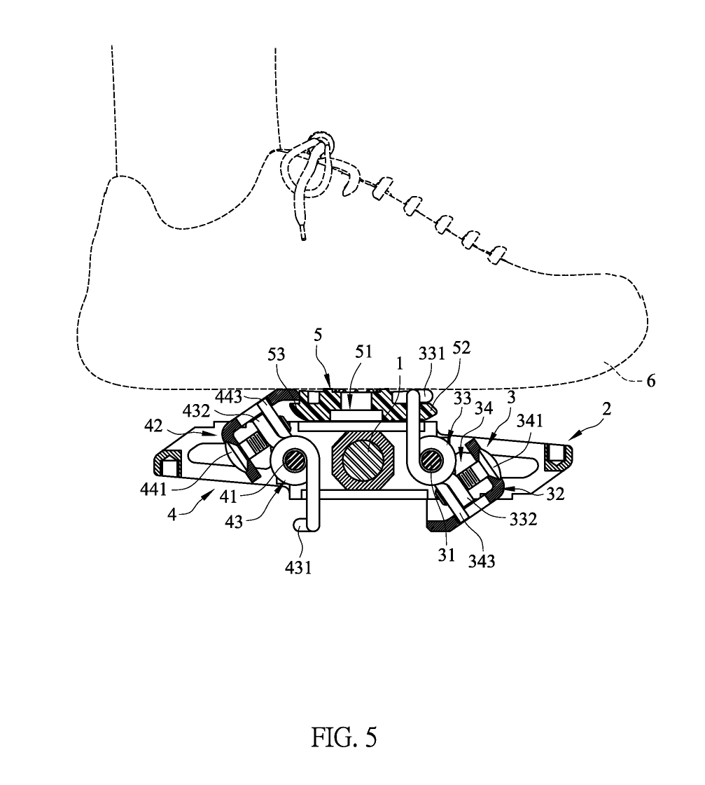

Referring to FIGS. 1, 2, 3, 4, 5, and 6, which are respectively a perspective view of the present invention, an exploded view of the present invention, a top plan view of the present invention, another top plan view of the present invention, a schematic view illustrating adjustment made according to the present invention, and a schematic view illustrating a released state of a clip block according to the present invention, as shown in the drawings, the present invention provides a bicycle pedal, which comprises at least a rotation axle 1, a pedal body 2, a first adjustment mechanism 3, a second adjustment mechanism 4, and a clip block 5.

The rotation axle 1 has an end to which a bearing 11 is mounted and an opposite end comprising a threaded section 12 formed thereon.

The pedal body 2 is coupled, in a movable manner, to the rotation axle 1 and comprises an axle sleeve section 21, hollowed areas 22, 23 respectively arranged in front and rear sides of the axle sleeve section 21, and a first retention block assembly 24 and a second retention block assembly 25 respectively arranged on opposite surfaces of the axle sleeve section 21. The rotation axle 1 is received, with the end thereof to which the bearing 11 is mounted, in the axle sleeve section 21 in such a way that the threaded section 12 extends beyond and outside an end of the axle sleeve section 21.

The first adjustment mechanism 3 is arranged in the hollowed area 22 and comprises a fixing bolt 31 arranged in the hollowed area 22, a holding seat 32 fit over the fixing bolt 31 and abutting one side of the first retention block assembly 24, an elastic element 33 fit over the fixing bolt 31 and having an end abutting one side of the second retention block assembly 25, and an adjustment section 34 movably mounted to the holding seat 32 and abutting an opposite end of the elastic element 33, wherein the holding seat 32 has a surface on which a graduation section 321 is provided and the holding seat 32 has an end that forms an extension tab 322 on which the adjustment section 34 is mounted. The elastic element 33 comprises a torsion spring and the elastic element 33 has an end that forms an abutment section 331 abutting one side of the second retention block assembly 25 and an opposite end that forms a pulling section 332 abutting the adjustment section 34. Further, the adjustment section 34 comprises an adjustment screw 341 extending through and coupled to the extension tab 322 and a pull plate 342 mounted to the adjustment screw 341. The pull plate 342 has a surface positioned against the pulling section 332 and the pull plate 342 has an end forming an indication section 343 corresponding to the graduation section 321.

The second adjustment mechanism 4 is arranged in the hollowed area 23 and comprises a fixing bolt 41 arranged in the hollowed area 23, a holding seat 42 fit over the fixing bolt 41 and abutting an opposite side of the second retention block assembly 25, an elastic element 43 fit over the fixing bolt 41 and having an end abutting an opposite side of the first retention block assembly 24, and an adjustment section 44 movably mounted to the holding seat 42 and abutting an opposite end of the elastic element 43, wherein the holding seat 32 has a surface on which a graduation section 421 is provided and the holding seat 42 has an end that forms an extension tab 422 on which the adjustment section 44 is mounted. The elastic element 43 comprises a torsion spring and the elastic element 43 has an end that forms an abutment section 431 abutting one side of the first retention block assembly 24 and an opposite end that forms a pulling section 432 abutting the adjustment section 44. Further, the adjustment section 44 comprises an adjustment screw 441 extending through and coupled to the extension tab 422 and a pull plate 442 mounted to the adjustment screw 441. The pull plate 442 has a surface positioned against the pulling section 432 and the pull plate 442 has an end forming an indication section 443 corresponding to the graduation section 421.

The clip block 5 is mounted, in a removable manner, between the first adjustment mechanism 3 and the second adjustment mechanism 4. The clip block 5 comprises a mounting hole 51 formed in a middle portion thereof and the clip block 5 has an end that forms a first constraint section 52 and an opposite end that forms a second constraint section 53. The first constraint section 52 is fit in the abutment section 331, 431 of the elastic element 33, 43 and the second constraint section 53 is fit in and abuts an inside surface of the holding seat 32, 42. As such, the combination of the above-described technical features forms a novel bicycle pedal.

To use the present invention, the threaded section 12 of the rotation axle 1 is mounted to a bicycle for pedaling. A user may use the first adjustment mechanism 3 and the second adjustment mechanism 4 to make adjustment of tightness on opposite surfaces of the pedal body 2. The clip block 5 can be used in combination with pads and screws to couple to a bottom of a competition shoe 6 worn on the user so that in riding the bicycle, the first adjustment mechanism 3 and the second adjustment mechanism 4 may clamp the clip block 5 in position. To make an adjustment, the first adjustment mechanism 3 and the second adjustment mechanism 4 are set to the same level of tightness so that the same clamping force can be achieved for use no matter which side of the pedal body 2 is rotated upward.

When a rider conducts an adjustment with the first adjustment mechanism 3 and the second adjustment mechanism 4 (adjusting tightness being taken as an example for illustration), a tool (not shown) is selected to correspond to and rotate the adjustment screws 341, 441 of the adjustment sections 34, 44 in such a way that the adjustment screws 341, 441 lift the pull plates 342, 442 upward and also drive the pulling sections 332, 432 of the elastic elements 33, 43 to move in unison therewith. The indication sections 343, 443 of the pull plates 342, 442 may be used in combination with the graduation sections 321, 421 to show the condition of adjustment, whereby the rider may readily realize the extent of adjustment that has been made. Further, since the abutment sections 331, 431 of the elastic element 33, 43 each abut one side of the second retention block assembly 25 and the first retention block assembly 24, when the pulling sections 332, 432 of the elastic element 33, 43 are lifted upwards, each of the elastic elements 33, 43 apply a force, through the abutment section 331, 431 thereof, to the second retention block assembly 25 and the first retention block assembly 24, while the pulling section 332, 432 applies a force to the holding seat 32, 42, so that the abutment section 331, 431 and the pulling section 332, 432 are set in a condition of applying force in the same direction thereby allowing the elastic elements 33, 43 to achieve an effect of clamping from both sides. For example, when the torsion force of each of the elastic elements 33, 43 is set to 10 Kg, a resultant torsion force of 20 Kg may be achieved due to the abutment section 331, 431 and the pulling section 332, 432 applying forces in the same direction.

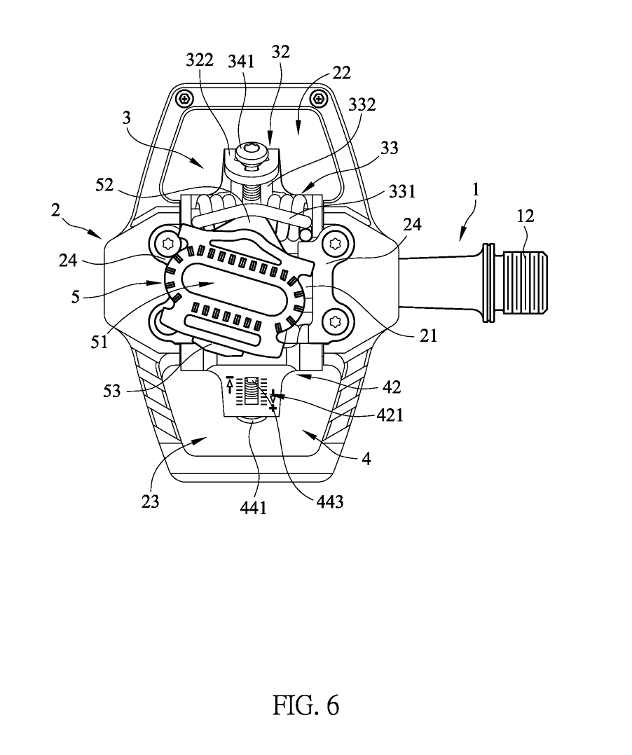

After the adjustment described above, both surfaces of the pedal body 2 can be set upwards to allow the driver to use a clip block 5 provided on the bottom of the competition shoe 6 to directly apply a force to the abutment section 331, 431 of the elastic element 33, 43 and the holding seat 32, 42 so as to have the first constraint section 52 of the clip block 5 directly fit into the abutment section 331, 431 of the elastic element 33, 43 and the second constraint section 53 fit to and abut the inside surface of the holding seat 32, 42 to be securely clamped thereby. TO release, the rider twists the competition shoe 6 to one side to have the first constraint section 52 and the second constraint section 53 of the clip block 5 disengage from the abutment section 331, 431 and the inside surface of the holding seat 32, 42 (as shown in FIG. 6).

In summary, the present invention provides a bicycle pedal that effectively overcomes the drawbacks of the prior art devices and allows two ends of an elastic element to respectively abut against the first or second retention block assembly and the adjustment section. The adjustment section allows an elastic element to be adjusted for torsion force in such a way that clamping from both sides can be achieved to significantly improve tightness and secureness of clamping a clip block.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A bicycle pedal, comprising:
a rotation axle;
a pedal body, which is movably coupled to the rotation axle and comprises an axle sleeve section, hollowed areas respectively formed in opposite sides of the axle sleeve section, and a first retention block assembly and a second retention block assembly respectively arranged on opposite surfaces of the axle sleeve section;
a first adjustment mechanism, which is arranged in one of the hollowed areas and comprises a fixing bolt arranged in the hollowed area, a holding seat fit over the fixing bolt and abutting one side of the first retention block assembly, an elastic element fit over the fixing bolt and having an end abutting one side of the second retention block assembly, and an adjustment section movably mounted to the holding seat and abutting an opposite end of the elastic element;
a second adjustment mechanism, which is arranged in another one of the hollowed areas and comprises a fixing bolt arranged in the hollowed area, a holding seat fit over the fixing bolt and abutting an opposite side of the second retention block assembly, an elastic element fit over the fixing bolt and having an end abutting an opposite side of the first retention block assembly, and an adjustment section movably mounted to the holding seat and abutting an opposite end of the elastic element; and
a clip block, which is mounted, in a removable manner, between the first adjustment mechanism and the second adjustment mechanism.

2. The bicycle pedal according to claim 1, wherein the rotation axle has an end to which a bearing is mounted and an opposite end comprising a threaded section formed thereon, the bearing being received in the axle sleeve section, the threaded section extending beyond and outside an end of the axle sleeve section.

3. The bicycle pedal according to claim 2, wherein each of the holding seats has a surface on which a graduation section is provided and each of the holding seats has an end that forms an extension tab on which the adjustment section is mounted.

4. The bicycle pedal according to claim 3, wherein the elastic element of the first adjustment mechanism comprises a torsion spring and the elastic element has an end that forms an abutment section abutting one side of the second retention block assembly and an opposite end that forms a pulling section abutting the adjustment section.

5. The bicycle pedal according to claim 4, wherein the elastic element of the second adjustment mechanism comprises a torsion spring and the elastic element has an end that forms an abutment section abutting one side of the first retention block assembly and an opposite end that forms a pulling section abutting the adjustment section.

6. The bicycle pedal according to claim 5, wherein each of the adjustment sections comprises an adjustment screw extending through and coupled to the extension tab and a pull plate mounted to the adjustment screw, the pull plate having a surface positioned against the pulling section.

7. The bicycle pedal according to claim 6, wherein each of the pull plates has an end forming an indication section corresponding to the graduation section.

8. The bicycle pedal according to claim 7, wherein the clip block comprises a mounting hole formed in a middle portion thereof and the clip block has an end that forms a first constraint section and an opposite end that forms a second constraint section, the first constraint section being fit in the abutment section of one of the elastic elements, the second constraint section being fit in and abutting an inside surface of one of the holding seats.
